(19) United States
(12) Patent Application Publication
(10) Pub. No.: US 2006/0064347 A1
(43) Pub. Date: Mar. 23, 2006

(54) Product information search, linking and distribution system

(75) Inventors: Andrew Robinson, Apple Valley, MN (US); Bill Adam, Sandy Hook, CT (US)

Correspondence Address: FOGG AND ASSOCIATES, LLC, P.O. BOX 581339, MINNEAPOLIS, MN, 55458-1339, US

(73) Assignee: HOMETOWN INFO, INC., Minneapolis, MN (US)

(21) Appl. No.: 10/943,802

(22) Filed: Sep. 17, 2004

(51) Int. Cl. G06Q 30/00

(52) U.S. Cl. 705/14

(57) ABSTRACT

The present invention relates to the linking of product information. In one embodiment, a method of providing information regarding grocery items is disclosed. The method comprises displaying grocery items for sale with a graphic user interface (GUI). Providing recipe links on the GUI associated with select grocery items for sale and displaying recipes upon activation of a recipe link.

### TECHNICAL FIELD

The present invention relates generally to the description of products for sale and in particular the linking of product information.

### BACKGROUND

The ability to obtain information in fast and efficient manner is of great benefit in today's society. It is common to find all adults of a household working outside of the home to make ends meet. This does not leave much time to do the shopping or preparing food for the family. Moreover, this situation is further complicated when a person in the household requires special dietary needs. In these cases, shopping is further complicated because the nutritional value in each ingredient in a meal has to be calculated. Accordingly, a cookbook is usually first consulted to determine what type of recipe to make for the meal. The items that make up the recipe must then be bought at a grocery store. Each item's nutritional value is then determined by reading the nutritional fact printed on each item. The aggregate per serving nutritional value of all of the items in a recipe must then be determined. If the nutritional value does not meet the nutritional requirements of the individual with the special dietary needs another meal must be prepared.

The use of personal computers and the internet has greatly increased the efficiency of modern day life. For example, the internet could be used to research recipes for meals and even the nutritional values of food items. However, here again it would take a considerable amount of time to calculate the per serving nutritional value in a recipe. Moreover, another problem is determining the cost of meal without going to the grocery store and calculating the cost of each item and adding them up.

For the reasons stated above and for other reasons stated below which will become apparent to those skilled in the art upon reading and understanding the present specification, there is a need in the art for an improved method of obtaining recipes along with nutritional and cost data.

### SUMMARY

The above-mentioned problems and other problems are resolved by the present invention and will be understood by reading and studying the following specification.

In one embodiment, a method of providing information regarding grocery items is disclosed. The method comprises displaying grocery items for sale with a graphic user interface (GUI). Providing recipe links on the GUI associated with select grocery items for sale and displaying recipes upon activation of a recipe link.

In another embodiment, a method of selecting products is disclosed. The method includes displaying available products on a graphic user interface (GUI). Providing recipe links on the GUI, each recipe link being associated with one of the available products. In response to the activation of a recipe link, generating a list of recipes related to the associated available product, and filtering the list of recipes with select parameters.

In further another embodiment, a method of providing information relating to a product is disclosed. The method comprises determining if a universal product code (UPC) barcode is being used. When a UPC barcode is being used, interfacing the UPC barcode to determine an associated product in a first database. Once the product has been determined, linking the product with related information in a second database and filtering the related information pursuant to select parameters.

In still another embodiment, a computer-readable medium having computer-executable instructions for performing a method is disclosed. The method comprises generating a list of recipes containing a selected product. Calculating the per serving nutritional value of each recipe. Filtering the list of recipes with select parameters and providing the filtered list of recipes.

In further still another embodiment, a product information system is disclosed. The system comprises a server, a first database and a second database. The server is in communication with a consumer interface. The consumer interface is adapted to display items for sale by a retailer. The user interface further has recipe links associated with select items for sale. The first database is in communication with the server. Moreover, the first database contains the recipes. The second database is also in communication with the server. The second database contains nutritional information relating to items in the recipes in the first database. In response to the activation of a recipe link, the server is adapted to retrieve recipes having the related item as an ingredient from the first data base and calculate the nutritional information per serving for each recipe using the nutritional information in the second database.

In yet still a further embodiment, a controller is disclosed. The controller includes a compiler. The compiler is adapted to recognize at least one of food names, alternative food names, relative food hierarchies, compound foods, referenced recipes, food preparations, cooking equipment names, preparation processes and cooking processes from text files presented to it.

### BRIEF DESCRIPTION OF THE DRAWINGS

The present invention can be more easily understood and further advantages and uses thereof more readily apparent, when considered in view of the description of the preferred embodiments and the following figures in which:

FIG. 1A is a flow diagram of one embodiment of the present invention;

FIG. 1B is an illustration of a GUI displaying a recipe link of one embodiment of the present invention;

FIG. 1C is an example of a GUI displaying a list of recipes displayed in response to the activation of a recipe link in one embodiment of the present invention;

FIG. 1D is an example of a GUI displaying a selected recipe and its corresponding nutritional facts of one embodiment of the present invention;

FIG. 1E is an example of a displayed manufactures coupon that has been customized in one embodiment of the present invention;

FIG. 2 is a block diagram of a product information system of one embodiment of the present invention;

FIG. 3 is a block diagram of a controller of one embodiment of the present invention; and

FIG. 4 is a product information flow diagram of one embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description of the preferred embodiments, reference is made to the accompanying drawings, which form a part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide an apparatus and method of searching information related to consumer products. In particular, embodiments of the present invention provide information such as recipes and nutritional information associated with the recipes. Moreover, embodiments of the present invention take into consider certain parameters such as a consumer's dietary requirements in determining which recipes to provide to the consumer. Other embodiments further provide coupon information regarding selected grocery items.

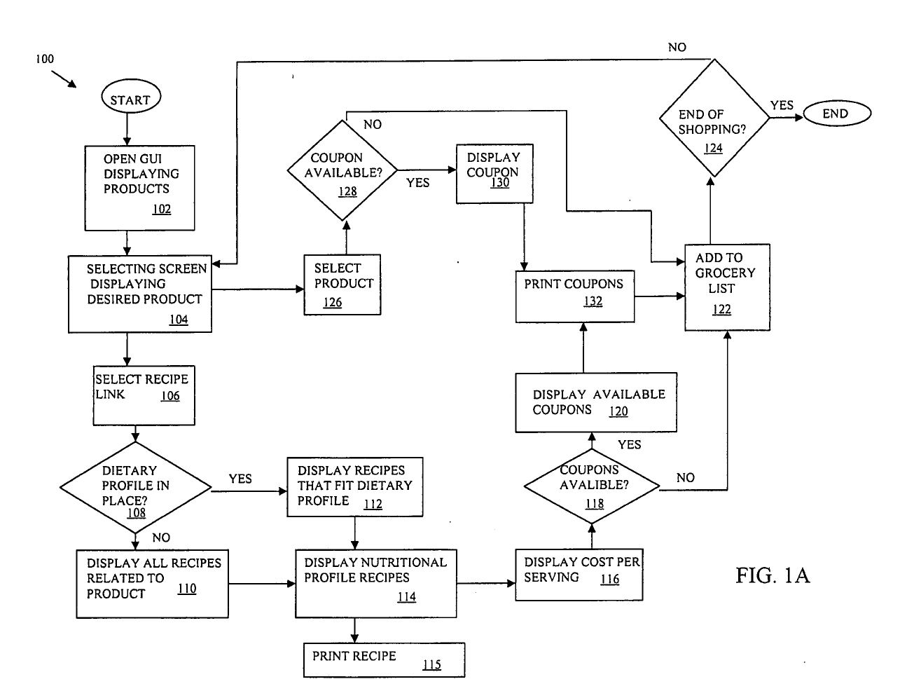

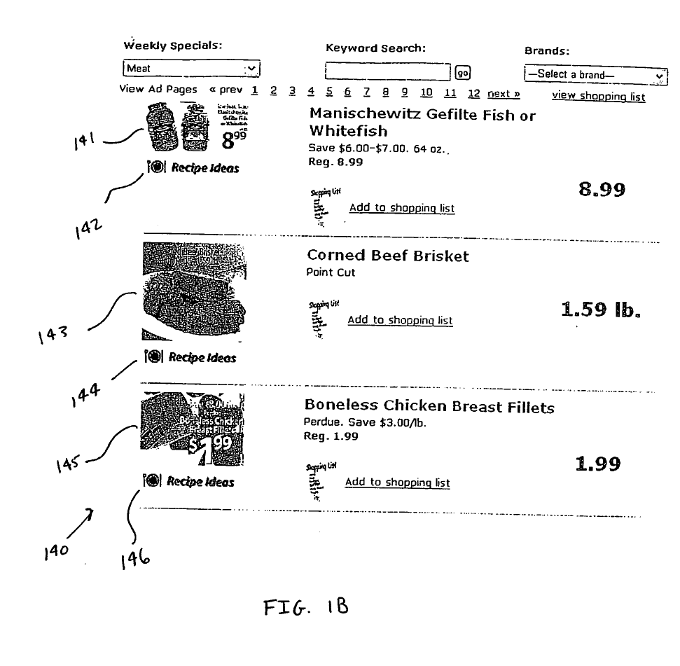

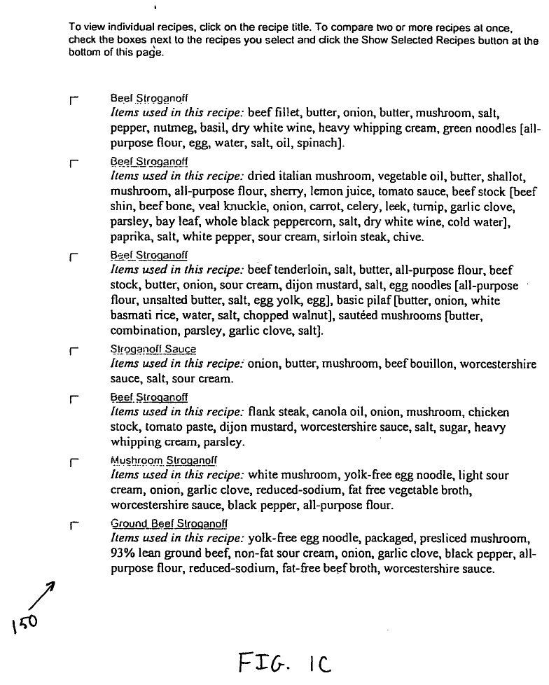

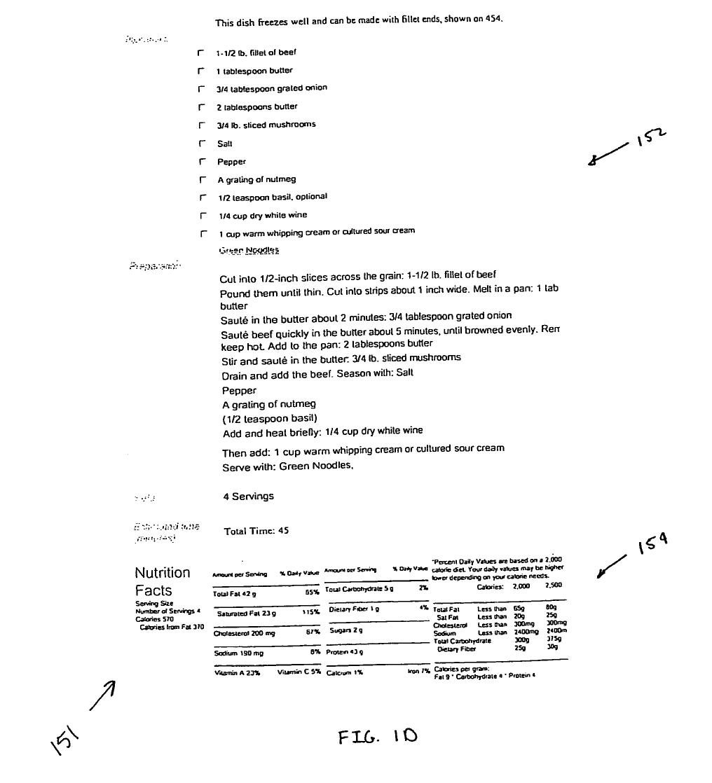

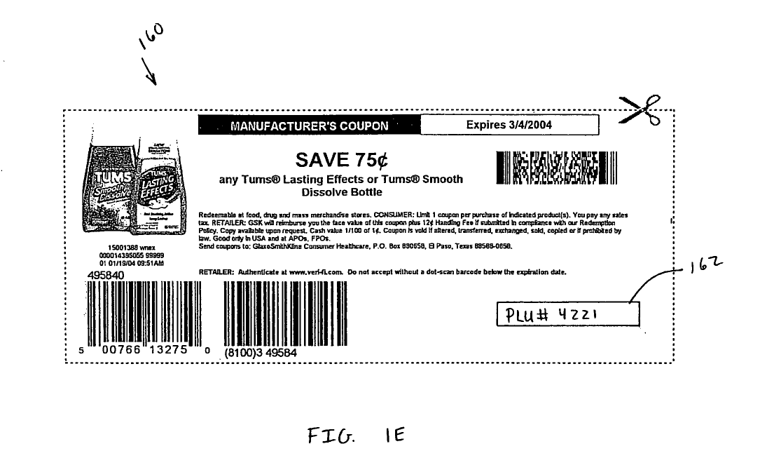

Referring to FIG. 1A, a flow diagram 100 of one embodiment of the present invention is illustrated. As illustrated, the flow diagram 100 begins by the user opening up a graphic user interface (GUI) that displays certain products such as groceries (102). Typically, this will occur at a grocery store's web site via the internet. However, in other embodiments this can occur at a kiosk in a grocery store over the internet or an in store intranet. The consumer then selects a screen displaying the desired products (104). Most products (or items) displayed have a recipe activation link that allows the consumer to link to recipes that involve the associated product. The recipes are stored in a recipe database. The consumer may then activate the recipe activation link (106). It is then determined if any dietary profiles are associated with the consumer (108). In one embodiment this is done by requiring the user (consumer) to use a unique password recognized by the system. The unique password is associated with a specific dietary profile. If no dietary profiles are associated with the consumer (108), all recipes related to the product are displayed (110). If a dietary profile is associated with the consumer (108), the recipes are filtered so that only recipes that meet those dietary needs are displayed (112). In other embodiments, other filters are used to select the recipes to be displayed. For example, the recipes may be filtered based on the consumers past shopping history, past coupon use or the retailer's current specials. In one embodiment two or more filters are used to sort the recipes to be displayed.

In the embodiment of FIG. 1A, the nutritional profile of each recipe is further displayed (114). The consumer then has the option of printing out the recipes (115). In further embodiments, the cost per serving is calculated and displayed for each recipe (116). It is then determined if any coupons (which may include traditional coupons, discounts, or temporary price reductions) are associated with items in selected recipes (118). If coupons are available (118), the coupons are displayed (120). In one embodiment, the coupons are sent via e-mail. The coupons can then be printed (132). Once the coupons are printed (132) or of no coupons are available (118), the consumer is given the option to add the items in the recipe to their personalized grocery list (122). The personal grocery list stores a list of the items the consumer desires. Once the consumer ends the shopping session, the list is provided to the consumer to print. In one embodiment, the consumer can opt to use the list as an order and have the grocery store gather and in some case deliver the groceries directly to the consumer.

Once an item is selected to be put on a grocery list, the consumer in this embodiment is queried as to whether they want to continue shopping or not (124). If consumer is finished shopping (i.e. finished looking for items) (124), the process ends. If the consumer is not done shopping (124), the selection screen displaying desired products is displayed (104). If a product (item) is selected (126) without a recipe request it is determined if coupons are available (128). If coupons are available (128) they are displayed to the consumer (130). They can then be printed out (130). Once the coupons are printed out (132) or if no coupons are available (128), the item is added to the shopping list (122). The consumer is then queried if this is the end of the shopping (124).

FIG. 1B is an example of a product description GUI 140 of one embodiment of the present invention. As illustrated FIG. 1B shows items for sale 141, 143 and 145. In this illustration, each of these items 141, 143 and 145 has a recipe idea link 142, 144 and 146 respectfully associated with it. Each recipe link 142, 144 and 146 is activated by clicking on the associated symbol. An example of recipes that could be brought up by activating the recipe link is illustrated in the recipe selection GUI 150 of FIG. 1C. Once a recipe is selected from the recipe selection GUI 150, a recipe GUI 151 is displayed as illustrated in FIG. 1D. In this embodiment, the recipe GUI 151 includes a recipe portion 152 and a nutritional portion 154. In other embodiments, the nutritional portion is displayed on a separate GUI upon request. An example of a coupon 160 is illustrated FIG. 1E. In this embodiment, the coupon 160 is adapted to include a retailer price lookup code (PLU) 162. This allows the retailer to modify manufactures coupons. In one embodiment select text can be added such as the retailer's name. This allows manufactures coupons to be store specific.

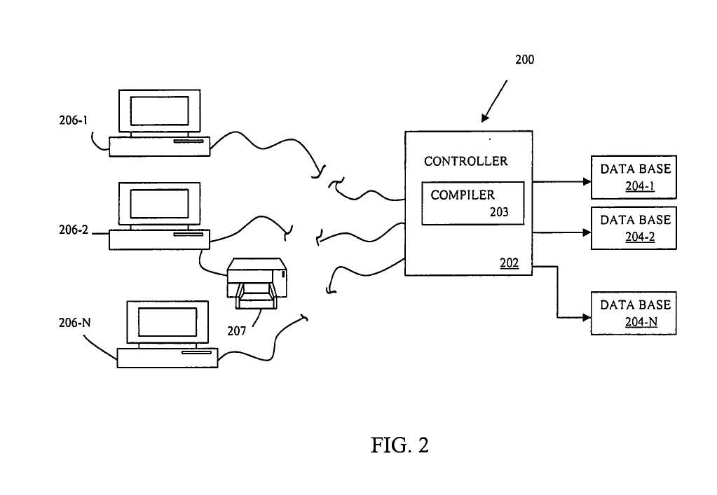

FIG. 2 illustrates a product information system 200 of one embodiment of the preset invention. As illustrated, the system includes a plurality of computers 206 (1-N), a controller 200 and a plurality of data bases 204 (1-N). The computers 206 (1-N) provide access to the system by the consumer. That is, the consumer provides data and receives data through their associated computer 206 (1-N). The computers are in communication with the controller 200. In one embodiment, at least one of the computers 206 (1-N) is a personal computer (PC) attached to the controller 200 via the internet. In another embodiment, at least one of the computers 206 (1-N) is located in a kiosk in a store. Further in one embodiment, at least one of the computers 206-2 is coupled to a printer 207 so that shopping lists, recipes and coupons can be printed. In one embodiment, recipes can be printed in a format that is easily archived in a recipe card.

The databases 204 (1-N) contain data such as recipes, nutritional values of food items, consumers shopping history and specific dietary requirements. The databases 204 (1-N) in this invention can be any type of data source or information table. Each database 204 (1-4) is in communication with the controller 202. The controller 202 in one embodiment is a server having a processor adapted to perform instructions. The controller of claim 200 includes a compiler 203. The compiler 203 in this embodiment is adapted to read recipes and electronically index food information. For example, the complier 203 is adapted to recognize food names, alternative food names, relative food hierarchies, compound foods, referenced recipes, food preparations, cooking equipment names, preparation processes and cooking processes from text files presented to it.

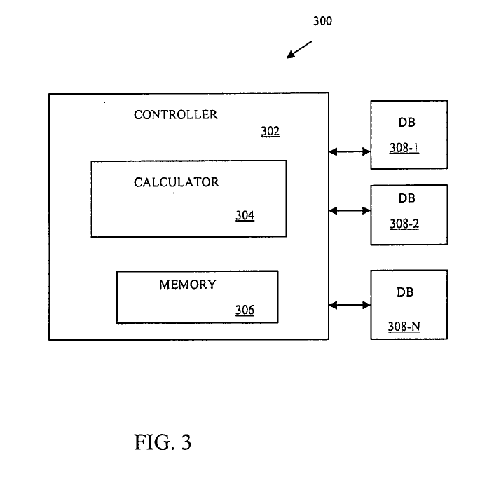

Embodiments of the present invention also include a nutritional calculator function adapted to calculate the per serving nutritional values of a meal. Referring to FIG. 3, a server system 300 of one embodiment having a calculator 304 of the present invention is illustrated. In particular, the server system 300 includes a controller 302 and databases 308 (1-N). The controller 302 includes a calculator 304 and a memory 306. The calculator 304 is adapted to calculate aggregate nutrition per serving for recipes. For example in one embodiment, once the nutritional values of ingredients are retrieved from an associated database 308 (1-N) and temporary stored in memory 306, calculator 304 calculates the aggregate nutritional value in a select recipe per serving. In one embodiment, once the nutritional value has been calculated for a recipe it is stored in an associated database 308 (1-N) for future reference. Further in one embodiment, the nutritional value for a recipe is displayed to the consumer in a standard nutritional facts format found on most packaged food products. In other embodiments, the presentation of the nutritional values is customizable.

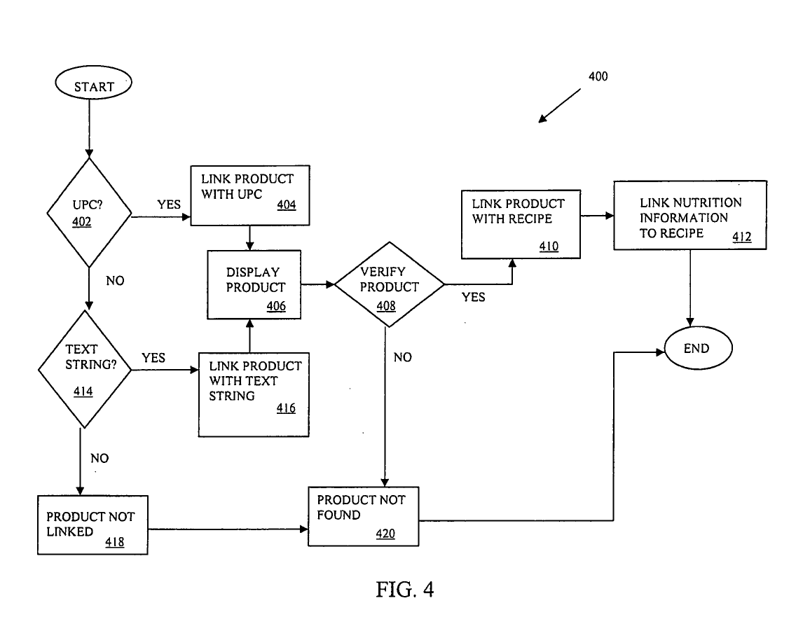

In one embodiment, food data is mapped by its associated universal product code (UPC) barcode. As a result, product searches can be conducted directly from a transmitted UPC barcode as well as a text string. A product finding flow chart 400 of one embodiment of the present invention is illustrated in FIG. 4. Flow chart 400 illustrates the use of UPC barcodes. As illustrated, it is first determined if a UPC barcode is being used to select a product (402). If a UPC barcode is used (402), it is linked with its associated product (404). The product is then displayed (406) to allow verification (408). If it is not the correct product (408), a “product not found” message is generated and displayed (420). If it is the correct product (408), the consumer may link the product with a recipe (410). Once a recipe has been selected (410), the nutritional information per serving of the recipe is determined and displayed (412). If it is not a UPC barcode (402), it is determined if it is a text string (414). If it is not a recognizable text string (414), a product is not linked (418) and a “product not found” message is generated and displayed (420). If it is a text string (416), an associated product is linked thereto (416). The product is then displayed (406) for verification (408). If it not the correct product (408), a “product not found message” is created and displayed (420). If it is the correct product (408), the consumer may link the product with a recipe (410). Once a recipe has been selected (410), the nutritional information per serving of the recipe is determined and displayed (412).

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory previously or now known or later developed, including by way of example semiconductor memory devices, such as erasable programmable read-only memory (EPROM), electrically erasable programmable read-only memory (EEPROM), and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although specific embodiments have been illustrated and described herein, it will be appreciated by those of ordinary skill in the art that any arrangement, which is calculated to achieve the same purpose, may be substituted for the specific embodiment shown This application is intended to cover any adaptations or variations of the present invention. For example, although, the above invention is illustrated in relation to grocery items, the same process can be used for other types of products that benefit from multilevel information. Therefore, it is manifestly intended that this invention be limited only by the claims and the equivalents thereof.

1. A method of providing information regarding grocery items, the method comprising:
displaying grocery items for sale with a graphic user interface (GUI);
providing recipe links on the GUI associated with select grocery items for sale; and
displaying recipes upon activation of a recipe link.

2. The method of claim 1, further comprising:
calculating the nutritional value per serving of displayed recipes; and
displaying the calculated nutritional values on the GUI.

3. The method of claim 1, further comprising:
determining nutritional requirements of consumers; and
displaying only recipes that meet the nutritional requirements of the consumer.

4. The method of claim 1, further comprising:
determining preferences of a consumer based on the consumer's shopping purchase history; and
displaying recipes based on the preferences.

5. The method of claim 1, further comprising:
linking coupons to ingredients in recipes.

6. The method of claim 1, further comprising:
determining a historic coupon usage of a consumer; and
displaying recipes based on the historic coupon use of the consumer.

7. The method of claim 1, further comprising:
linking coupons to ingredients in recipes; and
sending the coupons to a consumer via e-mail.

8. The method of claim 1, further comprising:
determining preferences of a consumer based on the consumer's shopping purchase history; and
linking coupons based on the preferences.

9. The method of claim 1, further comprising:
determining the dietary needs of a consumer; and
linking coupons based on the dietary needs.

10. The method of claim 1, further comprising:
linking retailer coupons to ingredients in recipes; and
customizing the coupons pursuant a retailers requirements.

11. The method of claim 1, further comprising:
processing text searches to determine grocery items desired by a consumer.

12. The method of claim 1, further comprising:
processing universal product code (UPC) barcodes to determine grocery items desired by a consumer.

13. A method of selecting products comprising:
displaying available products on a graphic user interface (GUI);
providing recipe links on the GUI, each recipe link being associated with one of the available products; and
in response to the activation of a recipe link,
generating a list of recipes related to the associated available product, and
filtering the list of recipes with select parameters.

14. The method of claim 13, wherein the select parameters are based on at least one of a consumer's dietary needs, a retailers specials and a consumer's shopping history.

15. The method of claim 13, further comprising:
displaying the filtered recipes.

16. The method of claim 13, further comprising:
e-mailing the filtered recipes to a user activating the recipe link.

17. The method of claim 13, further comprising:
calculating the nutritional value per serving for each filtered recipe.

18. The method of claim 13, further comprising:
calculating the cost per serving of each recipe.

19. The method of claim 13, further comprising:
linking coupons to the available products in the recipe.

20. The method of claim 13, further comprising:
providing customized manufactured sponsored coupons for the available products.

21. The method of claim 20, wherein the customized manufactured coupons include at least one of a retailer's price look up code and text.

22. The method of claim 20, further comprising:
distributing the manufacture sponsored coupons by at least one of the web, e-mail and in-store kiosk.

23. A method of providing information relating to a product, the method comprising:
determining if a universal product code (UPC) barcode is being used;
when a universal product code is being used, interfacing the UPC to determine an associated product in a first data source;
once the product has been determined, linking the product with related information in a second data source, wherein the related information is recipes;
filtering the related information pursuant to select parameters, wherein the select parameters arc nutritional requirements of a consumer;
calculating the nutritional value per serving of displayed recipes; and
displaying the calculated nutritional values on a GUI.

24. The method of claim 23, further comprising:
when a UPC barcode is not being used, processing a text string to determine a link between the text string and the products in the first data source.

25. (canceled)

26. (canceled)

27. The method of claim 23, further comprising;
providing customized manufactured coupons relating to the product.

28. The method of claim 27, wherein the customized manufacture coupon includes at least one of an added text and a price lookup code.

29. A computer-readable medium having computer-executable instructions for performing a method comprising:
generating a list of recipes containing a selected product;
calculating the per serving nutritional value of each recipe;
filtering the list of recipes with select parameters;
providing the filtered list of recipes.

30. The computer-executable instructions for performing a method of claim 29, further comprising:
determining the cost per serving of each recipe.

31. The computer-executable instructions for performing a method of claim 29, wherein the select parameters arc at least one of a consumer's dietary requirements, a consumer's past shopping history and a retailer's specials.

32. The computer-executable instructions for performing a method of claim 29, further comprising:
creating retailer customized manufacture coupons that include at least one of custom text and a price lookup code.

33. The computer-executable instructions for performing a method of claim 29, further comprising:
interfacing a universal product code (UPC) barcode to determine the selected product.

34. The computer-executable instructions for performing a method of claim 29, further comprising:
recognizing at least one of food names, alternative food names, relative food hierarchies, compound foods, referenced recipes, food preparations, cooking equipment names, preparation processes and cooking processes from text files.

35. The computer-executable instructions for performing a method of claim 29, further comprising:
indexing food information.

36. A product information system, the system comprising:
a server in communication with a consumer interface, the consumer interface adapted to display items for sale by a retailer, the user interface further having recipe links associated with select items for sale;
a first database in communication with the server, the first database containing the recipes; and
a second database in communication with the server, the second database containing nutritional information relating to items in the recipes in the first database;
wherein, in response to the activation of a recipe link, the server is adapted to retrieve recipes having the related item as an ingredient from the first data base and calculate the nutritional information per serving for each recipe using the nutritional information in the second database.

37. The system of claim 36, wherein the consumer interface is at least one of a retailer's web page and an in-store kiosk.

38. The system of claim 36, further comprising:
a third databases in communication with the server, the third database containing cost information for each item, wherein the server is further adapted to calculate the per serving cost of a recipe using the cost information in the third database.

39. The system of claim 36, wherein the server is further adapted to generate customized manufactured coupons.

40. The system of claim 36, further comprising:
a printer in communication with the server, the printer adapted to print out at least one of recipes, nutritional information and coupons.

41. The system of claim 36, wherein the server is further adapted to filter the recipes according to select parameters.

42. The system of claim 41, wherein the select parameters relate to at least one of a consumer's dietary requirements, a retailer's specials and a consumers past purchase history.

43. The system of claim 36, wherein the server further comprises:
a compiler adapted to recognize at least one of food names, alternative food names, relative food hierarchies, compound foods, referenced recipes, food preparations, cooking equipment names, preparation processes and cooking processes from text files presented to it.

44. The controller of claim 43, further comprising:
a calculator function adapted to aggregate nutritional values per serving for recipes: and
a memory adapted to temporary store nutritional values of ingredients.

45. A controller comprising:
a compiler adapted to recognize at least one of referenced recipes, food preparations, cooking equipment names, preparation processes and cooking processes from text files presented to it.

46. The controller of claim 45, wherein the compiler is further adapted to electronically index food information.

47. The controller of claim 45, further comprising:
a calculator function adapted to aggregate nutritional values per serving for recipes.

48. The controller of claim 47, further comprising:
a memory adapted to temporary store nutritional values of ingredients.

49. The controller of claim 45, wherein the controller is further adapted to link recipes based on at least one of UPC barcodes and text strings.

50. The controller of claim 49, further comprising:
a calculator function adapted to aggregate nutritional values per serving for recipes
